(19) United States
(12) Patent Application Publication
(10) Pub. No.: US 2023/0363590 A1
(43) Pub. Date: Nov. 16, 2023

(54) CAP ASSEMBLY FOR A BEVERAGE CONTAINER

(71) Applicant: SHAKACAN IP B.V., Amsterdam (NL)

(72) Inventors: Richard John NICHOLLS, Amsterdam (NL); Andrew Bryce NICHOLLS, Amsterdam (NL); Erwin Christiaan VAN LEEUWEN, Amsterdam (NL); Sebastiaan PRUISSCHER, Amsterdam (NL); Wouter Jan KAAN, Amsterdam (NL); Mike RESOORT, Amsterdam (NL)

(73) Assignee: SHAKACAN IP B.V., Amsterdam (NL)

(21) Appl. No.: 18/246,795

(22) PCT Filed: Sep. 27, 2021
(86) PCT No.: PCT/NL2021/050579

§ 371 Date: Mar. 27, 2023

(30) Foreign Application Priority Data
Sep. 28, 2020 (NL) 2026556

(51) Int. Cl. A47J 43/27; A47J 43/042; A47J 43/044; A47J 43/07; B65D 51/00

(52) U.S. Cl. CPC A47J 43/27; A47J 43/042; A47J 43/044; A47J 43/0705; B65D 51/007; B65D 2543/00351

(57) ABSTRACT

A shaker top and beverage container are provided, which may together form a cocktail shaker. The shaker top comprises an interface part arranged to be liquid-tightly connected to the beverage container, the interface part comprising an interface body and a radial clamping module for radially engaging the beverage container. The beverage container may be filled with a substantially non-carbonated beverage, for example up to 90 percent of the total volume of the beverage container.

### CROSS REFERENCE TO RELATED APPLICATIONS

The present application is a § 371 National Stage of International Application PCT/NL2021/050579, filed Sep. 27, 2021, which claims priority benefit of Dutch Pat. Application NL2026556, filed Sep. 28, 2020.

### FIELD OF THE INVENTION

The aspects and embodiments thereof relate to the field of cap assemblies for beverage containers.

### BACKGROUND OF THE INVENTION

For many cocktails, it is preferred that the beverage is shaken prior to being served. Shaking the beverage, for example with ice, may increase desired properties of the cocktail. Shaking may for example dilute the cocktail, cool the cocktail, mix ingredients of the cocktail together, and/or adjust the texture of the cocktail by virtue of the cocktail being aerated.

Many bartenders use a two-piece cocktail shaker set, comprising two shakers made from stainless-steel or glass. The cocktail may be assembled in one of the shakers, and after optionally adding ice, the shakers are connected to form a liquid-tight volume in which the cocktail can be agitated by shaking. For serving the cocktail, the shakers are disconnected and the cocktail is poured into a glass, optionally using a strainer to prevent solid particles such as ice from also being poured into the glass.

### SUMMARY OF THE INVENTION

It is preferred to provide bartenders but also consumers with a convenient means for shaking a cocktail, which for example requires less equipment, requires less cleaning of equipment and/or is more convenient in use.

A first aspect provides a shaker top for forming a cocktail shaker together with an at least partially pre-filled beverage container, such as an at least partially pre-filled beverage can. The shaker top comprises an interface part arranged to be liquid-tightly connected to the beverage container, the interface part comprising an interface body and a radial clamping module for radially engaging the beverage container.

An at least partially pre-filled beverage container may be a can, bottle, or other container for example comprising glass, aluminum, steel, tin-plated steel, plastic, any other material, or any combination thereof. The beverage container may be pre-filled at a filling plant and from there transported to a retail store. After being pre-filled, the beverage container may be sealed for transport for example via a removable lid or cap.

When shaking the can with beverage inside the can, and especially when there are solid particles such as ice cubes in the can as well, the shaker top is prone to forceful impacts. By virtue of the radial clamping module, the shaker top may be connected to the beverage container also when subjected to these impacts. The radial clamping module may for example clamp behind a flange of the beverage container, and as such restrict of fully block an axial movement of the shaker top relative to the beverage container.

As an option, the interface part may comprise a fluid inlet passage through the interface body and a fluid outlet passage through the interface body. The shaker top may as a further option comprise a cap part arranged to be connected to the interface part, and arranged to selectively block the fluid outlet passage and allow a fluid flow through the fluid outlet passage.

For example, after shaking the beverage, the beverage may be poured through the fluid inlet passage and the fluid outlet passage. As such, the interface part may remain connected to the beverage container during pouring as the cap part may be used to selectively seal the shaker top during shaking, and allow pouring of the beverage after shaking.

The radial clamping module comprises at least one cam protruding m a radial direction. The at least one cam may protrude radially inward towards a center line of the shaker top, or radially outward away from the center line of the shaker top.

The cap part may be rotationally connected to the interface part, such that the cap part can be rotated relative to the interface part between a first orientation wherein the cap part blocks the fluid outlet passage and a second orientation wherein the cap part allows a fluid flow through the fluid outlet passage.

As such, the cap part may remain connected to the interface part when the cap part blocks the fluid outlet passage and as well as when the cap part allows a fluid flow through the fluid outlet passage. Alternatively, for example, the cap part may be screwed onto or press into or onto the interface part to form a liquid tight seal.

The cap part may comprise a set of through holes provided adjacent to one another, and the cap part may be rotatable relative to the interface part to a third orientation in which the set of through holes is aligned with the fluid outlet passage. As such, a user may selectively block one or more of the through holes to select a particular flow through area for pouring the beverage through.

As a further option, the radial clamping module may comprise a plurality of fingers extending from the interface body, which fingers are provided with at least one radially extending cam. The radially extending cams provided on the fingers may extend towards a center line of the interface body, or may extend away from the center line of the interface body.

One or more or all of the fingers may be hingedly connected to the interface body. In particular, the one or more or all of the fingers may be arranged to be hinged away and/or towards a center line of the interface body. As such, the cams provided on the fingers may be moved radially away and/or towards the center line of the interface body.

Embodiments of the shaker top may comprise a locking ring surrounding at least part of the fingers. The locking ring may be arranged to be rotated relative to the interface part between a locking state in which the locking ring restricts hinging of the fingers and an unlocked state in which the locking allows hinging of the fingers. In particular, the locking ring may be rotated around a center line of the interface part.

As an even further option, embodiments of the shaker top may comprise a resilient sealing ring at least partially surrounded by the interface body. The sealing ring may be elastically deformed when the shaker top is connected to the beverage container to form a liquid tight seal between the shaker top and the beverage container.

In a further embodiment of the shaker top, the shaker top further comprises an axle protruding through the interface body, wherein at a first end, the axle is arranged to be rotated by an external motor, and a second end the axle is arranged to be connected to a tool for agitating a beverage.

The external motor may for example be provided by a kitchen appliance such as a blender. The tool for agitating the beverage may for example be a cutting tool with one or more blades for crushing ice, a mixer, or any other agitation tool. As such, the shaker top may be connected to the beverage container when the beverage container is in an upright position to form a liquid-tight shaker. Next, the shaker may be inverted and placed on the kitchen appliance to rotate the tool. Finally, the shaker may be placed upright again and the agitated beverage may be poured.

A second aspect provides a beverage container, which in particular may be arranged for forming a cocktail shaker with a shaker top according to the first aspect. The beverage container, which may for example be a can, in particular a beverage can, comprises a container body defining a beverage storage volume and comprising a container opening provided at a top section of the container body, a container flange extending radially outward from the container body at the top section, and a removeable lid covering the container opening, wherein the removeable lid is connected to the container body via a weakened section surrounding the removeable lid, a surface area of the removeable lid substantially corresponding to a surface area of the container opening, and wherein the container body is at least partially filled with a beverage.

To allow for additional ingredients to be added to the beverage inside the beverage container, for at most 90%, at most 80% or even at most 75% of the beverage storage volume may be filled with a beverage. Embodiments are even envisioned wherein at most 50%, at most 40% or even 33% or less of the beverage storage volume is filled with beverage. The remaining part of the beverage storage volume may for example be filled with air, or any other gas such as an inert gas, CO2, or any other gas with a lower oxygen content than air. Hence, when at the filling plant the lid is put on the beverage container, it may be less filled than conventional beverage containers of which the storage volume is typically filled with beverage for more than 95%.

The beverage may be a substantially non-carbonated beverage. The beverage may for example also be alcoholic or non-alcoholic, and may comprise one or more spirits, bitters, fruit juices, wines, mixers, any other type of beverage or any combination thereof.

The container body may comprise a metal, in particular aluminum or steel. As a further option, the surface area of the removeable lid corresponds to at least 50%, at least 75%, at least 80%, or even at least 90% of the surface area of the container opening.

A third aspect provides a kit of parts, comprising a shaker top according to the first aspect and a beverage container, in particular a beverage can, according to the second aspect. The shaker top may be arranged to be liquid-tightly connected with the beverage container to form a cocktail shaker by engaging the container flange of beverage container with the radial clamping module.

A fourth aspect provides a method of preparing a shaken beverage, comprising the steps of providing a beverage can filled with a beverage, in particular a non-carbonated alcoholic beverage, removing a removable lid covering a container opening of the beverage can, adding one or more ice cubes to the beverage in the beverage can through the container opening, liquid-tightly connecting a shaker top to the beverage container to form a cocktail shaker by engaging a container flange of the beverage container with a radial clamping module of the shaker top, and shaking the formed cocktail shaker, thereby allowing the beverage and preferably also ice cubes to pass back and forth through the container opening into the shaker top.

By virtue of the method according to the fourth aspect, a cocktail shaker is conveniently formed, of which for example the beverage can may be disposable. Furthermore, the beverage may have been at least partially premixed for convenience of the user. Next to one or more ice cubes, additional ingredients such as fresh ingredients, for example fruit juice or garnishes, may be added. After preparing the shaken beverage, the shaker top may be optionally at least partially disconnected from the beverage can and the shaken beverage may be poured. The shaker top may be reusable, whereas the beverage can may be disposed or recycled.

These and other objects, advantages and features of the invention will become apparent upon review of the following specification in conjunction with the drawings.

### BRIEF DESCRIPTION OF THE DRAWINGS

FIG. 1A shows a schematic front view of a can;

FIGS. 1B and 1C show top view of the can;

FIGS. 2A and 2B depict an embodiment of a beverage container assembly;

FIG. 3 shows an exploded view of another embodiment of a beverage container assembly;

FIG. 4 shows another exploded view of a beverage container assembly;

FIG. 5A shows a section view of a beverage container assembly;

FIG. 5B shows a detailed view of a beverage container assembly;

FIG. 6A depicts another embodiment of a beverage container assembly;

FIG. 6B depicts yet another embodiment of a beverage container assembly; and

FIG. 7 depicts a further embodiment of a beverage container assembly.

### DESCRIPTION OF THE PREFERRED EMBODIMENTS

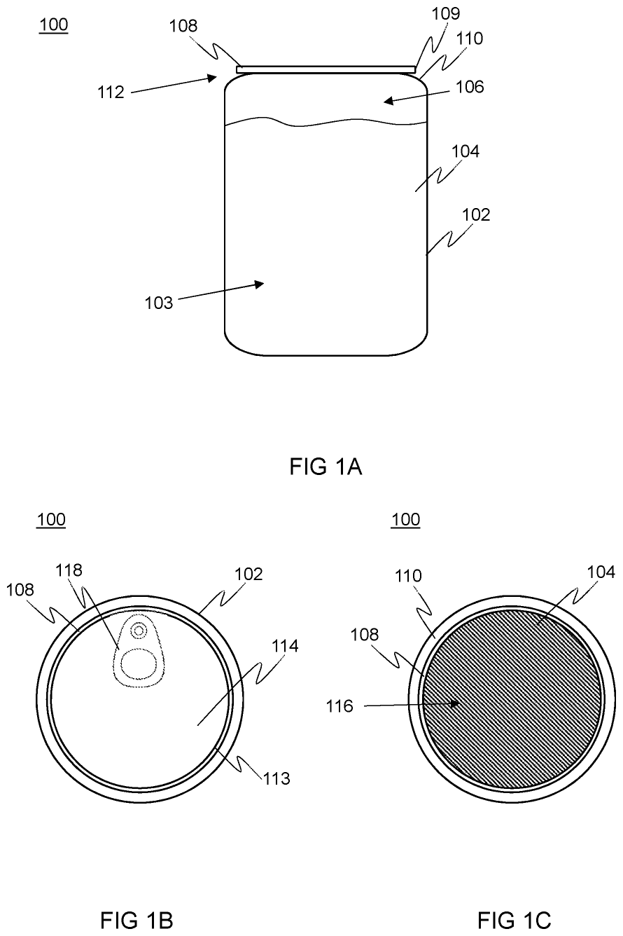

FIG. 1A shows a schematic front view of a can 100 as an example of a beverage container. FIGS. 1B and 1C show a top view of the can 100, respectively in a closed state and an opened state. The can 100 comprises a can body 102 as a container body. The can body 102 defines a beverage storage volume 103, in which a beverage 104 may be provided. As an option, the volume of beverage 104 inside the can body is lower than the total beverage storage volume. As such, a headspace 106 may be present.

This headspace 106 may allow a user to add additional contents to the can 100 without beverage 104 spilling out of the can 100. Examples of additional contents are ice cubes, garnished, beverages, mixers, syrups, foaming agents such as egg white and/or any other ingredient which may be comprised by a beverage such as a cocktail. Also, when no additional contents have to be added, the headspace 106 may allow for the beverage to be shaken within the beverage store volume 103.

In particular embodiments, only 95% or less of the beverage storage volume may be filled with beverage 104 at a filling plant. In other embodiments, this percentage may be 90% or less, 80% or less, or even 70% or less, to allow for a larger headspace 106. With a larger headspace 106, a larger volume of additional contents may be placed inside the can 100, for example prior to shaking and/or agitating the contents of the can. Embodiments of beverage containers substantially without a headspace are also envisioned.

In general, a beverage container may be filled with a non-carbonated or carbonated beverage, which may be a mixed beverage and may or may not comprise alcohol.

At a top section 112 of the container body 102, the can 100 comprises a rim 108 as a container flange. The rim 108 may originate from the manufacturing process of the can 100, where a lid may be folded together with a top end of the container body 102. Relative to the container body 102, the rim 108 extends radially outward, such that at an outer radius 109 of the rim 108, the rim 108 extends beyond the container body 102 at the height of the rim 108. For example, when the container body 102 comprises a shoulder 110, the outer radius of the rim 108 may extend over the shoulder 110. The furthest outer radius of the container body 102 may however extend radially further than the furthest outer radius of the rim 108—depending on the outer shape of the container body 102.

In the top view of FIG. 1B, the can 100 is shown comprising a user—removeable lid 114, which covers a top opening of the can 100. The top opening 116 is shown in FIG. 1C, where the can 100 is shown with the lid 114 removed. Through the top opening 116, the beverage 104 inside the can 100 becomes accessible. The lid 114 ensures that during transport and storage, beverage in the can 100 is sealed off from the environment.

The lid 114 may be connected to the can body 102 via a weakened section 113, which may entirely surround the lid 114. By virtue of the weakened section, the lid 114 may be teared off the can body 102 and may be fully discarded. As an option, the lid 114 may comprise a tab 118 which may aid the user in breaking the weakened section which releas ably connects the lid 114 to the can body 102.

As a further option, the weakened section 113 may not entirely surround the lid 114. As such, the lid 114 may remain attached to the can body 102 also when the top opening 116 is exposed. The lid 114 may be folded down into the can body 102.

As visible in FIG. 1C, the surface area of the top opening 116 of the can 100 substantially corresponds to a surface area delimited by and surrounded by the rim 108. The surface area of the top opening 116 may be larger than that of conventional cans which only have a drinking opening, and may hence allow passage of solid objects such as ice cubes next to allowing passage of beverage.

It is observed that when the surface area of the top opening 116 corresponds to a substantial part of the total surface area of the can 100 in the top view, the stiffness of the can body 102 may change. In particular, the can body 102 may become more prone to buckling under a weight pressing down on the can. As such, it may be preferred to use a radial clamping action to connect an interface part to the can when the lid 114 is removed.

A radial clamping action may be radially inward and/or radially outward. A radially inward clamping action may be performed on an outer wall of the can body 102, and a radially outward clamping action may be performed on an inner wall of the can body 102.

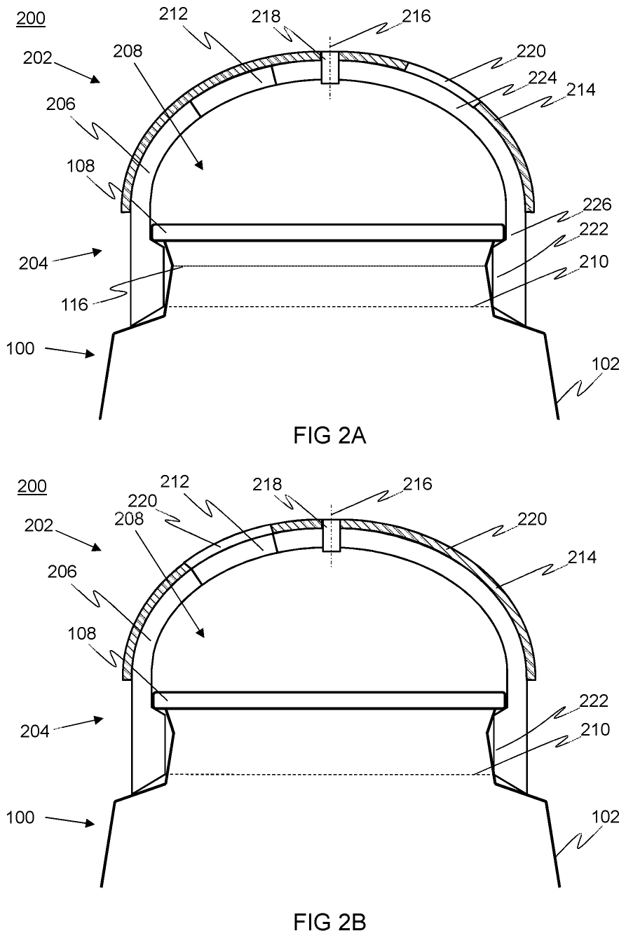

FIGS. 2A and 2B depict an embodiment of a beverage container assembly 200, comprising a can 100 as a beverage container and an embodiment of a shaker top 202. The beverage container assembly 200 is depicted in an assembled state, wherein the shaker top 202 liquid-tightly connects to the can 100. Only a top section of the can 100 is depicted for conciseness of the figures.

The shaker top 202 comprises an interface part 204 which is in the assembled state liquid-tightly connected to the can 100. The interface part 204 comprises an interface body 206, which may surround a chamber 208. The chamber 208 comprises a fluid inlet passage 210 and a fluid outlet passage 212. Both the fluid inlet passage 210 and the fluid outlet passage 212 allow passage of a fluid through the interface body 204.

The shaker top 202 further comprises a cap part 214, which is as an option in the assembled state connected to the interface part 204. In the particular embodiment of FIGS. 2A and 2B, as an option, the cap part 214 is rotatably connected to the interface part 204. As such, the cap part 214 may be rotated over a rotation axis 216 relative to the interface part 204. As an option, the cap part 214 is connected via a rotational joint 218 protruding out of the interface part 204 away from chamber 208.

The cap part 214 comprises a beverage passage 220 as a further option. In FIG. 2A, the beverage container assembly 200 is shown in a closed state, with the beverage passage 220 misaligned with the fluid outlet passage 212. As such, flow of beverage through the fluid outlet passage 212 is blocked. In FIG. 2B, the beverage container assembly 200 is shown in an open state. In this open state, the beverage passage 220 is aligned with the fluid outlet passage 212. A beverage passage 220 may be provided by one or more through holes, and/or by an omitted section of the cap part.

In the closed state, a liquid-tight chamber is created by the shaker top 202 and the can 100 which together form a cocktail shaker. As such, for example, in the closed state, a beverage can be shaken by shaking the beverage container assembly 200 without beverage leaking out. When the beverage is ready to be poured, the cap part 214 may be rotated over the rotation axis 216 to align the fluid outlet passage 212 with the beverage passage 220.

In embodiments, a cap part may comprise a single beverage passage 220. Alternatively, a cap part may comprise more than one beverage passage. For example, different beverage passages may provide different flow through areas or a plurality of beverage passages may each provide substantially the same flow though area, thus providing the functionality of a filter or a strainer. As such, solid particles such as ice or fruit seeds may be strained and/or filtered from the beverage while the beverage passes through the cap part.

As depicted in FIGS. 2A and 2B, the interface part 204 may comprise at least one cam 222 protruding from the interface body 204, for example into and/or towards the chamber 208. As an option, the cam 222 is shaped as a ring thus arranged to fully surround the can 100. In particular, the cam 222 in assembled state may hook behind the rim 108 of the can 100. As such, axial movement of the interface part 204 relative to the can 100 is restricted, and a liquid-tight seal may be achieved between the interface part 204 and the can 100.

To assemble the beverage container assembly 200—i.e., to couple the shaker top 202 to the can 100—as an option, the shaker top 202 may be axially pressed onto the can 100. When at least part of the interface part 204 such as the cam 222 is elastic and/or resilient, a press-fit coupling may be achieved between the interface part 204 and the can 100.

In particular, the interface body 206 may comprise a base surface 224 and a skirt part 226 extending from the base surface 224. A base surface 224 may be at least partially flat and/or at least partially spherical and/or at least partially dome-shaped. Together, the base surface 224 and the skirt part 226 may define the chamber 208. For example, the base surface 224 may comprise the fluid outlet passage 212 as a through hole through the base surface, and the skirt part 226 may define the fluid inlet passage 210. The volume of the chamber 208 may in embodiments be smaller than, equal to, or larger than the storage volume of the can 100.

In particular, the storage volume of the can may for example be approximately 200 mL, 250 mL, 330 mL, 350 mL, 500 mL. 568 mL or more. The volume of the chamber 208 may for example be at least 5%, at least 10%, at least 15% or even more than 20% of the storage volume of the can.

When the shaker top 202 is liquid-tightly connected to the can 100 after the lid 114 of the can 100 has been removed to expose the top opening 116, beverage and other contents of the can 100 such as ice may be moved between the can 100 and the chamber 208. As such, sufficient volume may be provided for shaking, mixing, and/or aerating the beverage.

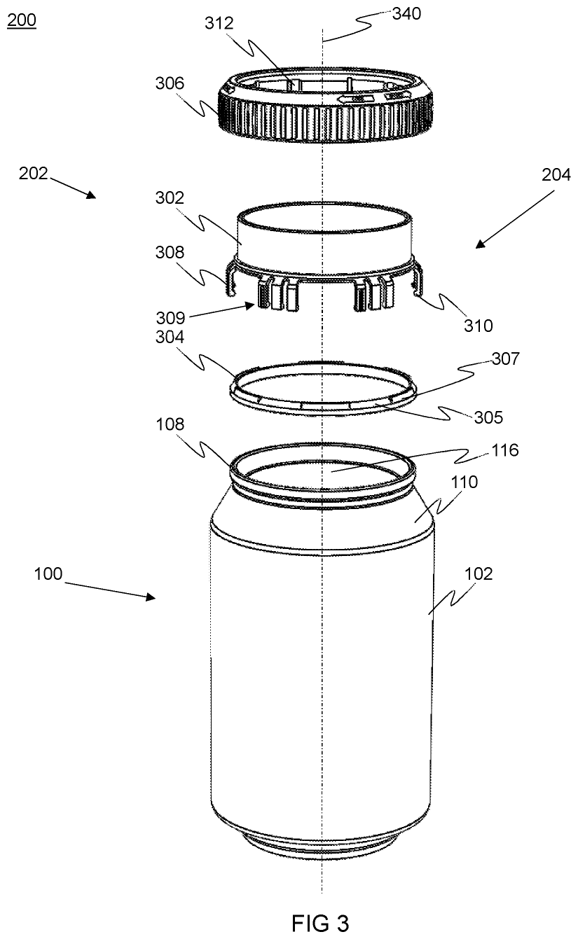

FIG. 3 shows an exploded view of another embodiment of a beverage container assembly 200, in particularly comprising the can 100 and another embodiment of the shaker top 202.

The interface part 204 of the shaker top 202 as depicted in FIG. 3 comprises a click ring 302 as an interface body, and further comprises a sealing ring 304 and an index ring 306 as a locking ring. In FIG. 3, the cap part has been omitted for conciseness of the figure. However, it will be understood that many different cap parts may be envisioned. A cap may be provided as being a separate part, as forming one part with the click ring 302, as forming one part with the index ring 306, other, or a combination thereof.

Such cap parts may be arranged to be liquid-tightly connected to the click ring 302. Cap parts may for example be at least partially dome—shaped. Cap parts may comprise elastic and/or resilient materials to be elastically deformed around and/or in the click ring 302 to form the liquid-tight connection. Next to a cap part, a strainer part maybe provided arranged to be connected to the click ring 302 and providing one or more strainer openings through which beverage may be poured while solid particles such as ice are filtered by the strainer part. The strainer part may also be formed by part of a cap part.

The click ring 302 comprises a plurality of fingers 308 as a radial clamping module extending away from the click ring 302. The click ring 302 may comprise any number of fingers, which fingers may for example be arranged in sets 309 of for example three fingers, as shown in FIG. 3. The fingers 308 or sets of fingers 309 may be distributed equally spaced around the click ring 302. For example, the fingers 308 may protrude in a direction substantially parallel to the center line 340 of the click ring 302.

At least some but preferably all fingers 308 comprise a cam 310 protruding in a radial direction. Radial ends of the cams 310 may be aligned on an imaginary circle, with a diameter corresponding to a diameter of a beverage container, preferably a diameter of the beverage container just below the rim 108. In particular, the cams 310 may protrude radially inward towards the center line 340 of the click ring 302. Preferably, the cams 310 are provided in a single flat imaginary plane. This plane may be substantially perpendicular to the center line 340 of the click ring 302.

The fingers 308 may be hingedly connected to the click ring 302, for example by virtue of the fingers 308 comprising an elastic and/or resilient material. When the fingers 308 hinge radially relative to the click ring 302, the diameter of the imaginary circle defined by radial ends of the cams 310 changes. In particular, this diameter may increase when the click ring 302 is pressed onto the rim 108 of the can 100.

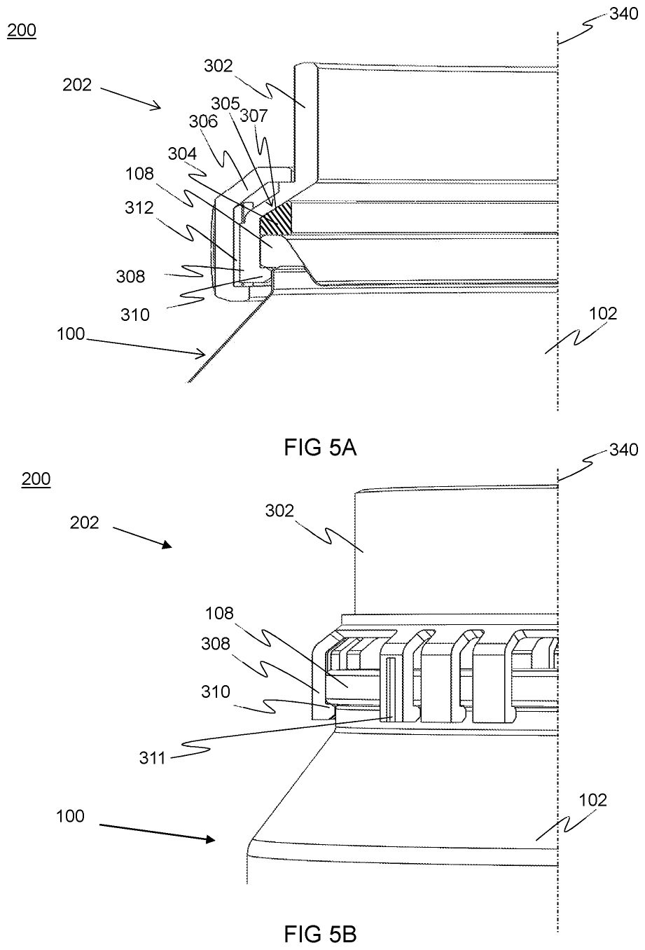

Hence, to connect the click ring 302 to the can 100, the click ring 302 may be axially pressed onto the can 100. During this connection, when the fingers 308 engage the can 100, in particular the rim 108, the fingers 308 may hinge radially outward. When the click ring 302 is pressed further onto the can 100, the fingers 308 may hinge back in place and the cams 310 clamp behind the rim 108. The cams 310 clamping behind the rim 108 will be further elaborated on in conjunction with FIGS. 5A and 5B.

As an option, the interface part 204 comprises the sealing ring 304. The sealing ring 304 may comprise or consist of resilient, compressible and/or elastic material which allow the sealing ring 304 to be elastically deformed to form a liquid-tight seal.

The sealing ring 304 may be chamfered and/or beveled at a top edge 307 thereof. As an even further option, the sealing ring 304 may comprise one or more dented sections 305 arranged to accommodate at least part of a finger 308 and or set of fingers 309.

As a further option, the interface part 204 comprises the index ring 306. In use, the index ring 306 is arranged to prevent the fingers 308 from hinging away from the can 100. As such, the index ring 306 may be used to lock the interface part 204 to the can 100. To prevent or at least restrict hinging movement of the fingers 308, the index ring 306 comprises one or more locking cams 312 protruding radially inward towards the center line 340. When the locking cams 312 are aligned with the fingers 308, a radially outward hinging movement of the fingers 308 may be restricted and as such the fingers 308 may remain clamped to the rim 108 even when an axial load is applied to the shaker top 202 which would otherwise disconnect the shaker top 202 from the can 100.

To align the locking cams 312 with the fingers 308, the index ring may be rotatable relative to the click ring 302. When the index ring is rotated relative to the click ring 302 around an axis parallel to the center line 340 of the click ring 302, the locking cams 312 may be selectively aligned and misaligned with the fingers 308.

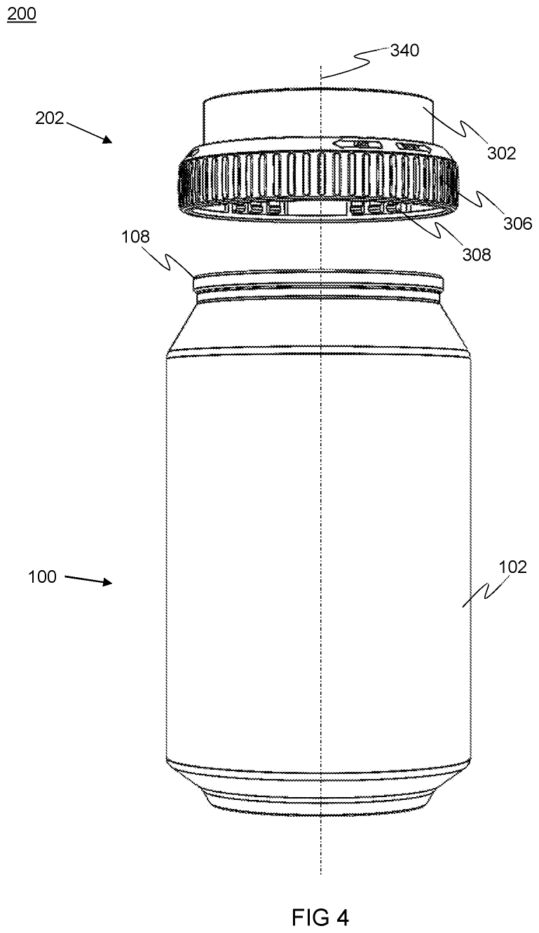

FIG. 4 shows another exploded view of the beverage container assembly 200, with the shaker top 202 in assembled state. In the assembled state of the shaker top 202, the index ring 306, click ring 302, and optional sealing ring (not visible) may be arranged coaxially around the center line 340 of the beverage container assembly 200. A top portion of the click ring 302 may extend beyond the index ring 306. This top portion may be arranged to connect a cap part to. Alternatively, the click ring 302 may comprise a cap part.

FIG. 5A shows a detailed section view of half of a top section of an assembled beverage container assembly 200. Only half of the top section is depicted since the assembly 200 may be substantially symmetric.

In the assembled state, the sealing ring 304 which is shown shaded may be deformed to form a liquid-tight seal between the shaker top 202 and the can 100. The deformation may for example comprise an axial compression and/or a radial compression of the sealing ring 304. In the embodiment of FIG. 5A, the sealing ring 304 seals on a top surface of the rim 108 of the can 100.

FIG. 5A also shows a cam 310 hooked behind the rim 108 of the can 100. As such, axial movement of the cap assembly relative to the can 100 may be restricted. To prevent the fingers 308 from bending or hinging radially away from the rim 108, the locking cam 312 may be rotated to be aligned with the fingers 308.

FIG. 5B shows in a detailed view how the fingers 308 with the cams 310 clamp behind the rim 108 of the can 100. In FIG. 5B, only the can 100 and the click ring 302 are shown—the sealing ring and index ring have been omitted for clarity of the figure.

As an option, at least one of the fingers 308 may comprise an indentation 311 and the index ring may comprise a protrusion arranged fit in the indentation 311. Alternatively, the index ring may comprise the indentation and at least one of the fingers may comprise the protrusion. When the protrusion at least partially protrudes into the indentation, the rotational position of the index ring may be locked relative to the fingers 308. As such, an additional force may be required to unlock the index ring, which in turn may indicate to a user that a lock is achieved and that shaking may commence.

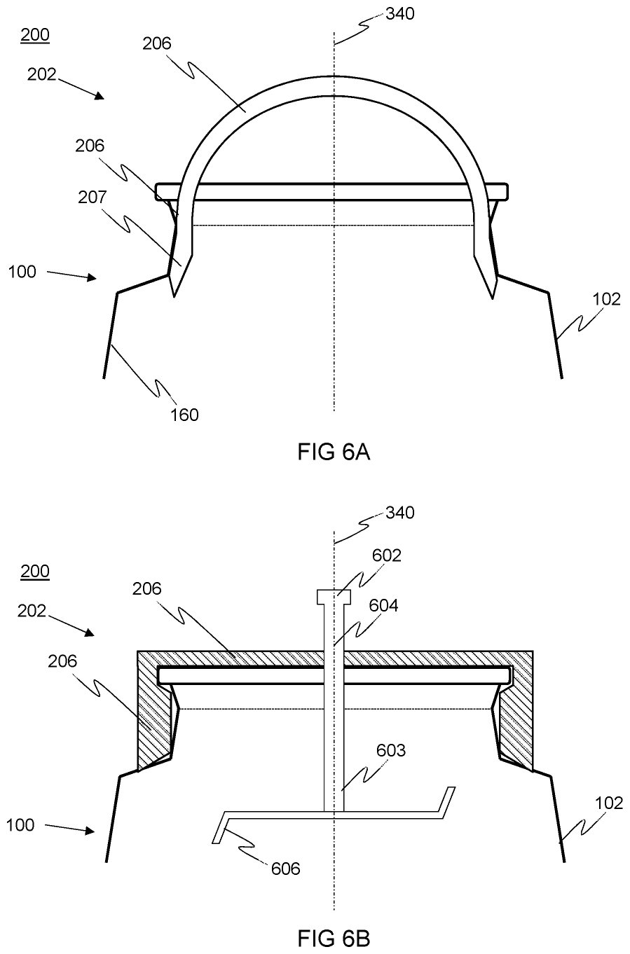

FIG. 6A depicts another embodiment of a beverage container assembly 200, with a further embodiment of a shaker top 202 connected to a can 100 as a beverage container. As an option, here, the shaker top 202 clamps radially to an inner wall 160 of the can 100. The interface body 206 comprises a skirt part 226 with a flared end 227 as a radial cam.

The flared end 227 may radially engage the can 100 at the inner wall 160 thereof. For example, at least the flared end 227 may be resilient and may hence be elastically deformed when engaging the inner wall 160 to form a liquid tight seal. To connect and/or disconnect the shaker top 202 from the can 100, at least part of the shaker top 202 may for example be twisted, folded, compressed, squeezed or pinched together. The flared end 227 may be provided with cams protruding outwardly to retain the shaker top 202 under the shoulder of the can body 102 below the rim 108.

FIG. 6B depicts yet another embodiment of a beverage container assembly 200, with a further embodiment of a shaker top 202 (shown shaded) connected to a can 100 as a beverage container. As an option, this shaker top 202 is provided with an axle 604 protruding through the interface body 206. In another implementation, the interface body 206 as depicted may be implemented as disclosed in other Figures and as described above.

The axle 604 is at a first end 602 rotatable by an external motor, for example comprised by a blender or other kitchen appliance. At a second end 603 of the axle 604, on an opposite side of the shaker top 202, a rotatable tool such as a knife 606, mixer, agitation device, or any other rotatable tool may be provided. The tool may be rigidly connected to the axle 604, or may be selectively connected to the axle 604 by a user.

In another implementation, at least one of the click ring 302 and the index ring 306 are arranged to be connected to a base of a blending tool, which base comprises an axle and knife equivalent to the knife 606 and the axle 604 as shown by FIG. 6B. Some bases of blending tools comprise a bayonet fitting for connecting the base to a glass or plastic can; the click ring 302, the index ring 306 or another body connectable to the can 100 may be provided with a bayonet fitting connectable to such base with a knife and an axle. This allows the knife to be driven by a motor of an electric kitchen appliance for agitating the beverage.

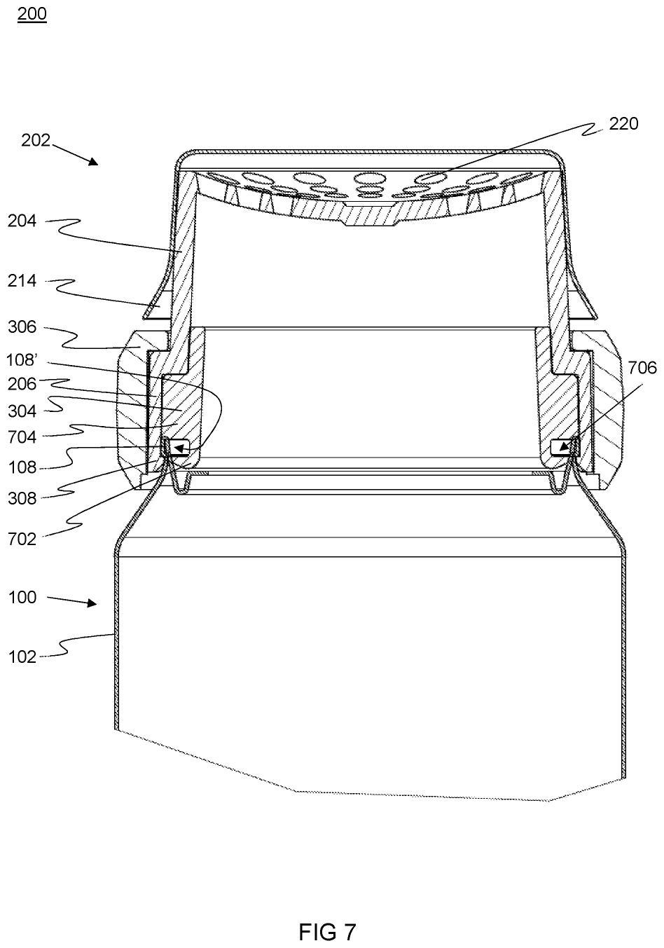

FIG. 7 shows in a schematic section view another embodiment of a beverage container assembly 200, comprising an embodiment of a can 100 and a particular embodiment of a shaker top 202. In FIG. 7, the can 100 is shown with the removable lid removed. The shaker top 202 is depicted liquid—tightly connected to the can 100, in particular to the rim 108 as a container flange of the can 100.

As a particular option, the shaker top 202 engages or clamps the rim 108 at the inside 108′ as well as the outside of the rim 108—or more in general, the shaker top 202 may also clamp or engage the can 100 from the inside outward, for example in a generally radial direction. As depicted in FIG. 7, the interface body 204 comprises one or more fingers 308, cams, or other protrusions oriented radially inward. The radially inward protrusions may be at least partially or fully ring-shaped—i.e., in use encircle the rim 108 at least partially or fully. Radially inward may imply towards a center line of the shaker top and/or in use generally towards a center line of the can 100.

The shaker top 202 comprises an optional cap part 214, which is removably connected to the interface part 204 of the shaker top 202. The interface part 204 comprises a plurality of beverage passages 220, and may hence resemble or function like a strainer arranged to catch ice and/or other particular when a beverage is poured through the beverage passages 220. An interface part 204 with a single or even no beverage passage is also envisioned.

To engage the inside 108′ of the rim 108, a sealing ring 304 is provided, which sealing ring 304 is in particular at least partially but preferably fully surrounded by the interface part 204. When the interface part 204 in the connected state surrounds the rim 108 of the can 100 from the outside, the sealing ring 304 may engage the rim 108 from the inside.

The sealing ring 304 may be resilient and/or elastic, and may hence be elastically deformed to comply or correspond to the shape of the rim 108. This in turn may ensure or improve a seal, in particular a liquid-tight seal, between the can 100 and the shaker top 202.

To engage the inside 108′ of the rim 108 or any other part on the inside of the can 100, the sealing ring 304 may comprise a hinging part 702 arranged to be hinged, to be bent, or to be otherwise elastically deformed relative to another part of the sealing ring 304. The hinging part 702 may be formed as a plurality of fingers protruding from the sealing ring 304, or as a ring-shaped part. The sealing ring 304 may further comprise a thickened section 704, arranged to in use be pressed onto a top of the rim 108 of the can 100, as shown in FIG. 7.

The hinging part 702 is arranged to be hinged or bent away from the interface part 204, in particular interface body 206. As such, the hinging part 702 may be hinged or bent towards a centerline of the shaker top 202. An annular space 706 is provided between the resilient sealing ring 304 and the interface part 204, in particular between the hinging part 702 and the interface body 206, for accommodating at least part of the can 100, in particular at least part of the rim 108.

The embodiment of the shaker top of FIG. 7 comprises several concentrically placed components, such as the interface part 204, the sealing ring 304, and the optional index ring 306. The index ring may not be required for example when the holding force or clamping force between the shaker top 202 and the can 100, in particular the rim 108, is sufficient. The index ring 306 may provide further insurance that the liquid-tight seal between the can 100 and the shaker top 202 is maintained also when vigorously shaking beverage and ice cubes inside the beverage container assembly 200.

In the embodiment of the shaker top of FIG. 7, the radial clamping module may be considered to comprise one or more of: the interface part 204, in particular interface body 206, even more in particular fingers or cams 308, and the sealing ring 304, in particular the hinging part 702.

Options disclosed in conjunction with the other embodiments, for example in conjunction with FIGS. 3, 4, 5A and 5B, may be readily applied to the embodiment of the shaker top 202 of FIG. 7—and vice versa.

In the description above, it will be understood that when an element such as layer, region or substrate is referred to as being “on” or “onto” another element, the element is either directly on the other element, or intervening elements may also be present. Also, it will be understood that the values given in the description above, are given by way of example and that other values may be possible and/or may be strived for.

Furthermore, the invention may also be embodied with less components than provided in the embodiments described here, wherein one component carries out multiple functions. Just as well may the invention be embodied using more elements than depicted in the Figures, wherein functions carried out by one component m the embodiment provided are distributed over multiple components.

It is to be noted that the figures are only schematic representations of embodiments of the invention that are given by way of non-limiting examples. For the purpose of clarity and a concise description, features are described herein as part of the same or separate embodiments, however, it will be appreciated that the scope of the invention may include embodiments having combinations of all or some of the features described.

The word ‘comprising’ does not exclude the presence of other features or steps than those listed in a claim. Furthermore, the words ‘a’ and ‘an’ shall not be construed as limited to ‘only one’, but instead are used to mean ‘at least one’, and do not exclude a plurality.

A person skilled in the art will readily appreciate that various parameters and values thereof disclosed in the description may be modified and that various embodiments disclosed and/or claimed may be combined without departing from the scope of the invention.

Changes and modifications in the specifically-described embodiments may be carried out without departing from the principles of the present invention, which is intended to be limited only by the scope of the appended claims as interpreted according to the principles of patent law including the doctrine of equivalents.

1. A shaker top for forming a cocktail shaker together with at least partially pre-filled beverage can, the shaker top comprising:
an interface part arranged to be liquid-tightly connected to the beverage can, the interface part comprising an interface body and a radial clamping module for radially engaging the beverage can.

2. The shaker top according to claim 1, wherein the interface part comprises a fluid inlet passage through the interface body and a fluid outlet passage through the interface body, and wherein the shaker top further comprises a cap part arranged to be connected to the interface part, and arranged to selectively block the fluid outlet passage and allow a fluid flow through the fluid outlet passage.

3. The shaker top according to claim 1, wherein the radial clamping module comprises at least one cam protruding in a radial direction.

4. The shaker top according to claim 3, wherein the at least one cam protrudes towards a center line of the shaker top.

5. The shaker top according to claim 2, wherein the cap part is rotationally connected to the interface part, such that the cap part can be rotated relative to the interface part between a first orientation where the cap part blocks the fluid outlet passage and a second orientation where the cap part allows a fluid flow through the fluid outlet passage.

6. The shaker top according to claim 5, wherein the cap part comprises a set of through holes provided adjacent to one another, and wherein the cap part can be rotated relative to the interface part to a third orientation in which the set of through holes is aligned with the fluid outlet passage.

7. The shaker top according to claim 1, wherein the radial clamping module comprises a plurality of fingers extending from the interface body, wherein the fingers are provided with at least one radially extending cam.

8. The shaker top according to claim 7, wherein the at least one radially extending cam extends towards a center line of the interface body.

9. The shaker top according to claim 7, wherein the fingers are hingedly connected to the interface body.

10. The shaker top according to claim 9, further comprising a locking ring surrounding at least part of the fingers, wherein the locking ring is arranged to be rotated relative to the interface part between a locking state where the locking ring restricts hinging of the fingers and an unlocked state where the locking allows hinging of the fingers.

11. The shaker top according to claim 1, further comprising a resilient sealing ring at least partially surrounded by the interface body.

12. The shaker top according to claim 11, wherein the resilient sealing ring comprises a hinging part arranged to be hinged relative to another part of the sealing ring in a direction away from the interface body.

13. The shaker top according to claim 11, wherein an annular space is provided between the resilient sealing ring and the interface part for accommodating part of the beverage can.

14. The shaker top according to claim 1, further comprising an axle protruding through the interface body, wherein a first end of the axle is arranged to be rotated by an external motor, and wherein a second end of the axle is arranged to be connected to a tool for agitating a beverage.

15. A beverage can comprising:
a container body defining a beverage storage volume and comprising a container opening provided at a top section of the container body;
a container flange extending radially outward from the container body at the top section; and
a removeable lid covering the container opening, wherein the removeable lid is connected to the container body via a weakened section surrounding the removeable lid, wherein a surface area of the removeable lid is substantially corresponding to a surface area of the container opening, and wherein the container body is at least partially filled with a beverage.

16. The beverage can according to claim 15, wherein at most 60% of the beverage storage volume is filled with the beverage.

17. (canceled)

18. (canceled)

19. The beverage can according to claim 15, wherein the container body comprises a metal such as aluminum or steel.

20. The beverage can according to, claim 15, wherein the surface area of the removeable lid corresponds to at least 50% of the surface area of the container opening.

21. A beverage container comprising:
a shaker top having an interface part that includes an interface body and a radial clamping module; and
a beverage can having a container body and a container flange extending radially outward from the container body, wherein the shaker top is arranged to be liquid-tightly connected with the beverage can to form a cocktail shaker by engaging the container flange of the beverage can with the radial clamping module.

22. The beverage container according to claim 21, wherein the shaker top is arranged to clamp the container flange of the beverage can on an inside and an outside of the container flange.

23. (canceled)
